(19) United States
(12) Patent Application Publication
(10) Pub. No.: US 2026/0252967 A1
(43) Pub. Date: Aug. 27, 2026

(54) DEVICE AND METHOD FOR PROCESSING SENSOR DATA

(71) Applicant: Robert Bosch GmbH, Stuttgart (DE)

(72) Inventors: Sascha Wirges, Buehl (DE); Ivan Batalov, Pittsburgh, PA (US); Nian Hua, Magstadt (DE)

(21) Appl. No.: 19/547,753

(22) Filed: Feb. 24, 2026

(30) Foreign Application Priority Data
Feb. 27, 2025 (DE) 10 2025 107 455.0

(51) Int. Cl. G06N 20/00

(52) U.S. Cl. CPC G06N 20/00

(57) ABSTRACT

A device and method for processing sensor data. The sensor data of the same modality are captured by sensors from different points. The sensor data characterize the same activity. The sensor data captured by the respective sensor are mapped with a model for machine learning to a respective representation of the activity in a common feature space. The model is trained with a target function. The target function characterizes a distance between the representations.

### FIELD

The present disclosure relates to a device and a method for processing sensor data.

### SUMMARY

According to an example embodiment, a method for processing sensor data, wherein sensor data of the same modality are recorded with sensors from different points, wherein the sensor data characterize the same activity, wherein by means of a model for machine learning the sensor data captured by the respective sensor are mapped to a respective representation of the activity in a common feature space, and wherein the model is trained using a target function, wherein the target function characterizes a distance between the representations. The method improves the expressiveness of the point-specific sensor data encoders.

It can be provided that the model comprises, for each representation, a point-specific sensor data encoder, wherein, during training of the model with the target function, the respective point-specific sensor data encoder is trained according to the target function to map the sensor data captured by the respective sensor to the respective representation.

It can be provided that the target function characterizes the distance between the representations by means of a respective distance of a specified representation to the respective other representations, wherein the model is trained to minimize the respective distance. The given representation serves as a reference.

For example, the specified representation or the sensor capturing the sensor data in order to determine the specified representation is specified. A representation suitable as a reference or a sensor suitable as a reference captures, for example, sensor data that characterize the activity better than other sensor data.

It may be intended that the sensors are synchronized with each other.

According to an example embodiment, it can be provided that during the same activity, respective sensor data are captured from the different points in different time periods, wherein, with the model, the representations of the sensor data captured in the time period are determined for each time period and assigned to the respective time period, wherein the target function comprises a measurement for a distance between representations assigned to at least two different time periods, and wherein the model is trained to maximize the measurement for the distance. The target function is formed, for example, as a contrastive loss.

In the inference phase, sensor data characterizing another activity are captured and are in each case mapped using the model to a respective representation of the other activity in the common feature space.

It can be provided that, according to the representations of the other activity, an output variable of the model is determined, wherein the output variable comprises information about the other activity generated with the model, in particular a digital image or audio signal or inertial sensor signal generated with the model or a spatial combination of a plurality of inertial sensor signals of the other activity, or information about a presence of an object, or a classification of an object generated with the model, or a result of a regression of a sensor signal of the same modality, or a result of a recognition as to whether the other activity is normal or exhibits an anomaly, or wherein the output variable comprises a control signal generated with the model for a technical system, in particular for a robot, a vehicle, a household appliance, a tool, a manufacturing machine, an access control system or a personal assistance system.

The model is trained, e.g. with sensor data captured by a first number of sensors, wherein the sensor data characterizing the Other activity are captured by a second number of sensors, wherein the second number is smaller than the first number. Due to the training with the larger number of sensors used for capturing the sensor data, the model is formed for the most precise possible representation of the activity. As a result, the inference with the model trained in this way is as good as possible despite the comparatively smaller number of sensors for capturing the sensor data.

It can be provided that the model is trained with sensor data from sensors that are arranged closer to the activity on which training is performed than are the sensors that capture the other activity. This improves the model.

It can be provided that the sensors each comprise a camera, wherein the modality comprises a digital image, and wherein the cameras capture digital images of the same activity from different viewpoints at the same time, or that the sensors each comprise a microphone, wherein the modality comprises audio, and wherein the microphones capture audio of the same activity at different recording points at the same time, or that the sensors each comprise an inertial measurement unit, wherein the modality comprises an inertial sensor signal of the inertial measurement unit or a spatial combination of a plurality of inertial sensor signals of the inertial measurement unit, and wherein the inertial measurement unit detects simultaneously the modality of the same activity at different recording points on a body performing the activity, in particular a body of a human, an animal, a vehicle or a robot.

For example, at least one of the cameras for capturing the sensor signals on which the model is trained is arranged closer to a face of a human or animal performing the activity than during the capture of the other activity. For example, at least one of the microphones for capturing the sensor signals on which the model is trained is arranged closer to a mouth of a human or animal performing the activity than during the capture of the Other activity.

According to an example embodiment, a device for processing sensor data provides that the device comprises at least one processor, at least one memory and sensors, wherein the at least one memory stores instructions which, when executed by the at least one processor, cause the device to perform the method.

A computer program for processing sensor data can be provided, wherein the computer program comprises instructions executable by a computer which, when executed by the computer, cause the computer to perform the method of the present disclosure.

Further examples can be found in the following description and the figures.

### BRIEF DESCRIPTION OF THE DRAWINGS

FIG. 1 schematically shows a device for processing sensor data, according to an example embodiment.

FIG. 2 shows a flowchart with steps of a method for processing the sensor data, according to an example embodiment.

### DETAILED DESCRIPTION OF EXAMPLE EMBODIMENTS

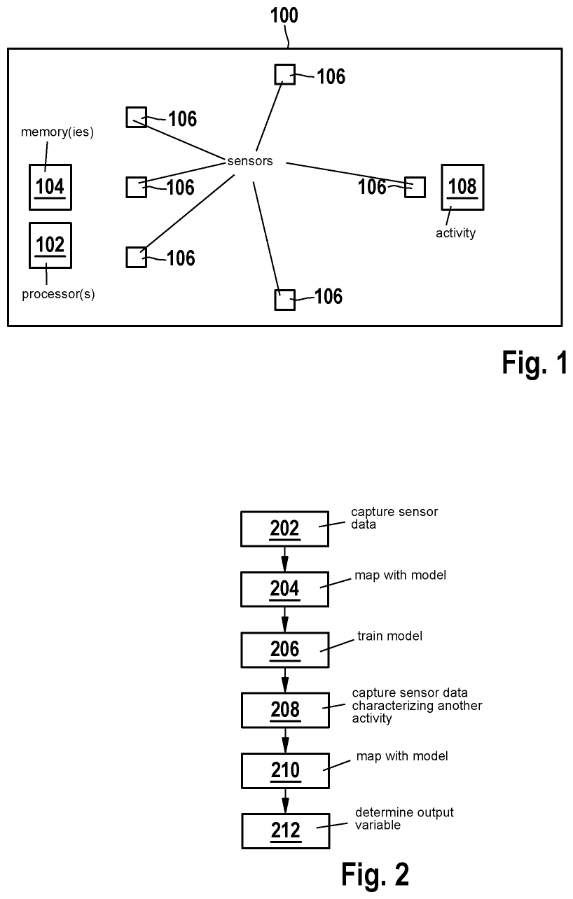

FIG. 1 schematically shows a device 100 for processing sensor data.

The device 100 comprises at least one processor 102, at least one memory 104 and sensors 106.

The device 100 comprises sensors 106. The sensors 106 are designed to capture sensor data of a activity 108.

The sensors 106 are designed to record sensor data from different points.

The sensors 106 are designed to capture sensor data of the same modality.

The sensor data characterize the same activity 108.

The at least one memory 104 stores instructions which, when executed by the at least one processor 102, cause the device 100 to perform a method for processing sensor data.

The method comprises a step 202.

In step 202, sensor data of the same modality are captured by sensors 106 from different points.

The sensor data characterize the same activity 108.

It may be intended that the sensors 106 are synchronized with each other. For example, during the same activity 108, respective sensor data are captured from the different points in different time periods.

The method comprises a step 204.

In step 204, the sensor data captured by the respective sensor 106 are mapped with a model for machine learning to a respective representation of the activity 108 in a common feature space.

In the example, the model comprises for each representation a point-specific sensor data encoder. The respective sensor data encoder is designed to map the sensor data captured by the respective sensor 106 to the respective representation.

For example, with the model the representations of the sensor data captured in the time period are determined for each time period and assigned to the respective time period.

The method comprises a step 206.

In step 206, the model is trained with a target function.

During the training of the model with the target function, in the example the respective point-specific sensor data encoder is trained according to the target function to map the sensor data captured by the respective sensor 106 in each case to a representation in the common feature space.

For example, the model is trained on the sensor data captured in the different time periods and their representations.

The objective function characterizes a distance between the representations.

According to one example, the target function characterizes the distance between the representations by means of a respective distance of one of the representations as a reference to the respective other representations. For example, one of the representations is specified as a reference. It can be provided that the sensor 106 is specified which captures the sensor data for determining the reference.

The model is trained, for example, to minimize the respective distance.

For the sensor data captured in the plurality of time periods, for example, the target function additionally comprises a measurement for a distance between the representations of the sensor data captured by the same sensor 106 from different time periods.

For the sensor data captured in the plurality of time periods, for example, the model is trained to maximize the respective measurement for the distance.

It can be provided that the training of the model then ends.

It can be provided that the method comprises a step 208.

In step 208, sensor data characterizing another activity are captured.

Next, a step 210 is performed.

In step 210, the sensor data characterizing the other activity are in each case mapped with the model to a respective representation of the other activity in the common feature space.

It can be provided that the number of sensors 106 for capturing the activity is the same.

It can be provided that the model is trained with sensor data captured by a first number of sensors 106.

It can be provided that the sensor data characterizing the other activity are captured by a second number of sensors 106.

The second number is smaller than the first number.

It can be provided that the model is trained with sensor data from sensors 106 that are arranged closer to the activity 108 on which training is performed than are the sensors 106 that capture the other activity.

For example, more sensors 106 arranged closer to the activity are used for training than for inference.

Training and inference can be carried out in the same space.

Training and inference can be carried out at different locations. The sensors 106 each comprise, e.g. a camera, wherein the modality comprises a digital image. The cameras capture, for example, digital images of the same activity 108 from different viewpoints at the same time.

The sensors 106 each comprise, e.g. a microphone, wherein the modality comprises audio. The microphones capture, for example, audio of the same activity 108 at different recording points at the same time.

The sensors 106 each comprise, e.g. an inertial measurement unit, wherein the modality comprises an inertial sensor signal of the inertial measurement unit or a spatial combination of a plurality of inertial sensor signals of the inertial measurement unit. The inertial measurement unit detects, for example, the modality of the same activity 108 at different recording points on a body performing the activity 108 at the same time.

The body is, for example, the body of a human, an animal, a vehicle, or a robot.

For example, at least one of the cameras for capturing the sensor signals on which the model is trained is arranged closer to a face of a human or animal performing the activity 108 than in the detection of the other activity.

For example, at least one of the microphones for detecting the sensor signals on which the model is trained is arranged closer to a mouth of a human or animal performing the activity than in the detection of the other activity.

The other activity is, for example, performed by the same performer. The other activity is, for example, performed by another performer.

It can be provided to perform a step 212 next.

In step 212, an output variable of the model is determined according to the representations of the other activity.

The output variable comprises, for example, information about the other activity.

The information comprises, for example, a digital image or audio signal or inertial sensor signal generated with the model or a spatial combination of a plurality of inertial sensor signals of the other activity.

The information includes, for example, information generated by the model about the presence of an object.

The information includes, for example, a classification of an object generated by the model.

The object is, for example, a vehicle, a human, an animal, infrastructure or a traffic sign.

The information comprises, for example, a result of a regression of a sensor signal of the same modality generated with the model. The information comprises, for example, a result generated with the model of a recognition as to whether the other activity is normal or exhibits an anomaly.

The output variable comprises, for example, a control signal generated with the model for a technical system.

The technical system is, for example, a robot, a vehicle, a household appliance, a tool, a manufacturing machine, an access control system or a personal assistance system.

The control signal is, for example, a signal for movement of the technical system or of the object or a part thereof.

The control signal is, for example, a signal for grasping or for preventing a collision with the object or a part thereof.

1-14. (canceled)

15. A method for processing sensor data, the method comprising the following steps:
capturing the sensor data of the same modality by respective sensors from different points, wherein the sensor data characterize the same activity; and
mapping the sensor data captured by each respective sensor of the respective sensors with a model for machine learning to a respective representation of the activity in a common feature space;
wherein the model is trained with a target function, wherein the target function characterizes a distance between the respective representations.

16. The method according to claim 15, wherein the model includes, for each of the respective representations, a point-specific sensor data encoder, wherein, during the training of the model with the target function, the respective point-specific sensor data encoder is trained according to the target function to map the sensor data captured by the respective sensor to the respective representation.

17. The method according to claim 15, wherein the target function characterizes the distance between the respective representations using a respective distance of a specified representation to the other respective representations, wherein the model is trained to minimize the respective distance.

18. The method according to claim 17, wherein the respective representation or the respective sensor capturing the sensor data for determining the respective representation is specified.

19. The method according to claim 15, wherein the respective sensors are synchronized with each other.

20. The method according to claim 15, wherein during the same activity, respective sensor data are captured from the different points in different time periods, wherein, using the model, respective representations of the sensor data captured in each respective time period are determined and assigned to the respective time period, wherein the target function includes a measurement for a distance between the respective representations assigned to at least two different time periods, and wherein the model is trained to maximize the measurement for the distance.

21. The method according to claim 15, wherein sensor data characterizing another activity are captured and are in each case mapped with the model to a respective representation of the other activity in the common feature space.

22. The method according to claim 21, wherein, according to the representations of the other activity, an output variable of the model is determined, wherein:
the output variable includes information about the other activity generated with the model includes: a digital image or audio signal or inertial sensor signal generated with the model or a spatial combination of a plurality of inertial sensor signals of the other activity, or information about a presence of an object, or a classification of an object generated with the model, or a result of a regression of a sensor signal of the same modality, or a result of a recognition as to whether the other activity is normal or exhibits an anomaly, or
the output variable includes a control signal generated with the model for a technical system including at least one of a robot, a vehicle, a household appliance, a tool, a manufacturing machine, an access control system, or a personal assistance system.

23. The method according to claim 21, wherein the model is trained with sensor data captured by a first number of sensors, wherein the sensor data characterizing the other activity are captured by a second number of sensors, and wherein the second number is smaller than the first number.

24. The method according to claim 21, wherein the model is trained with sensor data from sensors that are arranged closer to the activity on which training is performed than are the sensors that capture the other activity.

25. The method according to claim 15, wherein:
the respective sensors each include a camera, wherein the modality includes a digital image, and wherein the cameras capture digital images of the same activity from different viewpoints at the same time, or
the respective sensors each include a microphone, wherein the modality comprises audio, and wherein the microphones simultaneously capture audio of the same activity at different recording points, or
the respective sensors each include an inertial measurement unit, wherein the modality includes an inertial sensor signal of the inertial measurement unit or a spatial combination of a plurality of inertial sensor signals of the inertial measurement unit, and wherein the inertial measurement unit detects simultaneously the modality of the same activity at different recording points on a body performing the activity, the body including a body of one of: a human, an animal, a vehicle or a robot.

26. The method according to claim 25, wherein:
at least one of the cameras for capturing the sensor signals on which the model is trained is arranged closer to a face of a human or animal performing the activity than in the capture of the other activity, or
at least one of the microphones for capturing the sensor signals on which the model is trained is arranged closer to a mouth of a human or animal performing the activity than in the capture of the other activity.

27. A device for processing sensor data, the device comprising:
at least one processor;
at least one memory; and sensors;
wherein the at least one memory stores instructions which, when executed by the at least one processor, cause the device to perform the following steps:
capturing the sensor data of the same modality by respective sensors of the sensors from different points, wherein the sensor data characterize the same activity; and
mapping the sensor data captured by each respective sensor of the respective sensors with a model for machine learning to a respective representation of the activity in a common feature space;
wherein the model is trained with a target function, wherein the target function characterizes a distance between the respective representations.

28. A non-transitory computer-readable medium on which is stored a computer program for processing sensor data, the computer program including instructions executable by a computer which, when executed by the computer, cause the computer to perform the following steps comprising:
capturing the sensor data of the same modality by respective sensors from different points, wherein the sensor data characterize the same activity; and
mapping the sensor data captured by each respective sensor of the respective sensors with a model for machine learning to a respective representation of the activity in a common feature space;
wherein the model is trained with a target function, wherein the target function characterizes a distance between the respective representations.
